(19) United States
(12) Patent Application Publication
(10) Pub. No.: US 2010/0124329 A1
(43) Pub. Date: May 20, 2010

(54) ENCRYPTED COMMUNICATION BETWEEN PRINTING SYSTEM COMPONENTS

(76) Inventor: Dan C. Lyman, Cincinnati, OH (US)

Correspondence Address: Andrew J. Anderson;Patent Legal Staff, Eastman Kodak Company, 343 State Street, Rochester, NY, 14650-2201, US

(21) Appl. No.: 12/272,824

(22) Filed: Nov. 18, 2008

(51) Int. Cl. H04K 1/00; H04L 9/28

(52) U.S. Cl. 380/255; 380/28

(57) ABSTRACT

A system and method of communicating between a first device and a second device are provided. The method includes providing unencrypted data to be transmitted in the first device, encrypting at least a portion of the unencrypted data to be transmitted to form encrypted data, using at least a portion of the encrypted data to form a first validation code, appending the first validation code to the unencrypted data to form a packet of data to be transmitted, and transmitting the packet of data from the first device to the second device. The first device and the second device can include inkjet printing system components.

### FIELD OF THE INVENTION

This invention relates generally to encrypted communication, and in particular to encrypted communication between printing system components.

### BACKGROUND OF THE INVENTION

In printing systems, for example inkjet printing systems, information is transmitted between various printing system components. Typically, this information is stored in the memory of one of the printing system components for later retrieval and use.

### SUMMARY OF THE INVENTION

According to one aspect of the present invention a system and method of communicating between a first device and a second device are provided. Communication includes transferring information or data in a secure manner without encrypting the information itself. When appropriate, the transferred information or data is used or stored by at least one of the first device and the second device.

According to another aspect of the present invention, a method of communicating between a first device and a second device includes providing unencrypted data to be transmitted in the first device, encrypting at least a portion of the unencrypted data to be transmitted to form encrypted data, using at least a portion of the encrypted data to form a first validation code, appending the first validation code to the unencrypted data to form a packet of data to be transmitted, and transmitting the packet of data from the first device to the second device.

According to another aspect of the present invention, a method of communicating between a first device and a second device also includes extracting the unencrypted data from the received packet of data, extracting the first validation code from the received packet of data, encrypting at least a portion of the extracted unencrypted data, using at least a portion of the extracted encrypted data to form a second validation code that is calculated by the second device, and comparing the second validation code to the first validation code. The portion of extracted unencrypted data encrypted by the second device corresponds to the portion of unencrypted data encrypted by the first device and the portion of the extracted encrypted data that forms the second validation code corresponds to the portion of the encrypted data that forms the first validation code.

According to another aspect of the present invention, an inkjet printing system includes a first device including unencrypted data to be transmitted, a second device, and a communication link between the first and second devices. The first device is configured to encrypt at least a portion of the unencrypted data to be transmitted to form encrypted data, to use at least a portion of the encrypted data to form a first validation code, and to append the first validation code to the unencrypted data to form a packet of data to be transmitted. The communication link is configured to transmit the packet of data from the first device to the second device.

According to another aspect of the present invention, an inkjet printing system also includes the second device being configured to extract the unencrypted data from the received packet of data, extract the first validation code from the received packet of data, encrypt at least a portion of the extracted unencrypted data, use at least a portion of the extracted encrypted data to form a second validation code, and compare the second validation code to the first validation code. The portion of extracted unencrypted data encrypted by the second device corresponds to the portion of unencrypted data encrypted by the first device and the portion of the extracted encrypted data that forms the second validation code corresponds to the portion of the encrypted data that forms the first validation code.

### BRIEF DESCRIPTION OF THE DRAWINGS

In the detailed description of the example embodiments of the invention presented below, reference is made to the accompanying drawings, in which:

FIG. 1 shows a simplified schematic block diagram of an example embodiment of a printing system made in accordance with the present invention;

FIG. 2 is a schematic view of an example embodiment of a continuous printhead made in accordance with the present invention; P FIG. 3 is a schematic view of an example embodiment of a continuous printhead made in accordance with the present invention;

FIG. 4 is a schematic block diagram of an example embodiment of an inkjet printing system made in accordance with the present invention showing the relationship between a jetting module and a host;

FIG. 5 is a flowchart of an example embodiment of the present invention showing a communication session for communicating encrypted data using a communication session specific key; and

FIG. 6 is a flowchart of an example embodiment of the present invention showing a method of communicating data between a first device and a second device.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide a printhead and/or printhead components typically used in inkjet printing systems. However, many other applications are emerging which use inkjet printheads to emit liquids (other than inks) that need to be finely metered and deposited with high spatial precision. As such, as described herein, the terms “liquid” and/or “ink” refer to any material that can be ejected by the printhead and/or printhead components described below.

Typically, inkjet printing is accomplished by one of two technologies, referred to as drop-on-demand inkjet printing and continuous inkjet printing. While the present invention finds application in various types of printing systems, it is particularly well suited for drop-on-demand inkjet printing systems and continuous inkjet printing systems.

In drop on demand ink jet printing, ink drops are generated for impact upon a print medium using a pressurization actuator (thermal, piezoelectric, etc.). Selective activation of the actuator causes the formation and ejection of an ink drop through a nozzle bore that strikes a print medium. The formation of printed images is achieved by controlling the individual formation of ink drops and relative movement of the recording medium and the printhead. A slight negative pressure within each channel keeps the ink from inadvertently escaping through the nozzle bore and also forms a slightly concave meniscus at the nozzle bore.

In continuous inkjet printing, a pressurized ink source is used to eject a filament of fluid through a nozzle bore from which a continuous stream of ink drops are formed using a drop forming device. The ink drops are directed to an appropriate location using one of several methods (electrostatic deflection, heat deflection, gas deflection, etc.). When no print is desired, the ink drops are deflected into an ink capturing mechanism (catcher, interceptor, gutter, etc.) and either recycled or disposed of. When print is desired, the ink drops are not deflected and allowed to strike a print media. Alternatively, deflected ink drops can be allowed to strike the print media, while non-deflected ink drops are collected in the ink capturing mechanism.

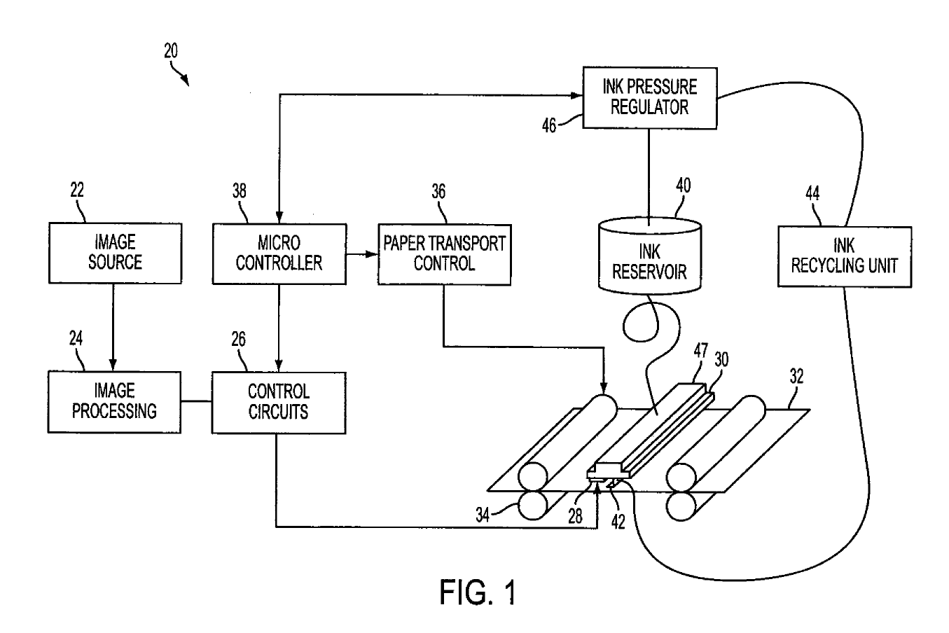

Referring to FIG. 1, an example embodiment of a continuous printing system made in accordance with the present invention is shown. A continuous printing system 20 includes an image source 22 such as a scanner or computer which provides raster image data, outline image data in the form of a page description language, or other forms of digital image data. This image data is converted to half-toned bitmap image data by an image processing unit 24 which also stores the image data in memory. A plurality of drop forming mechanism control circuits 26 read data from the image memory and apply time-varying electrical pulses to a drop forming mechanism(s) 28 that are associated with one or more nozzles of a printhead 30. These pulses are applied at an appropriate time, and to the appropriate nozzle, so that drops formed from a continuous ink jet stream will form spots on a recording medium 32 in the appropriate position designated by the data in the image memory.

Recording medium 32 is moved relative to printhead 30 by a recording medium transport system 34, which is electronically controlled by a recording medium transport control system 36, and which in turn is controlled by a micro-controller 38. The recording medium transport system shown in FIG. 1 is a schematic only, and many different mechanical configurations are possible. For example, a transfer roller could be used as recording medium transport system 34 to facilitate transfer of the ink drops to recording medium 32. Such transfer roller technology is well known in the art. In the case of page width printheads, it is most convenient to move recording medium 32 past a stationary printhead. However, in the case of scanning print systems, it is usually most convenient to move the printhead along one axis (the sub-scanning direction) and the recording medium along an orthogonal axis (the main scanning direction) in a relative raster motion.

Ink is contained in an ink reservoir 40 under pressure. In the non-printing state, continuous ink jet drop streams are unable to reach recording medium 32 due to an ink catcher 42 that blocks the stream and which may allow a portion of the ink to be recycled by an ink recycling unit 44. The ink recycling unit reconditions the ink and feeds it back to reservoir 40. Such ink recycling units are well known in the art. The ink pressure suitable for optimal operation will depend on a number of factors, including geometry and thermal properties of the nozzles and thermal properties of the ink. A constant ink pressure can be achieved by applying pressure to ink reservoir 40 under the control of ink pressure regulator 46. As shown in FIG. 1, catcher 42 is a type of catcher commonly referred to as a “knife edge” catcher.

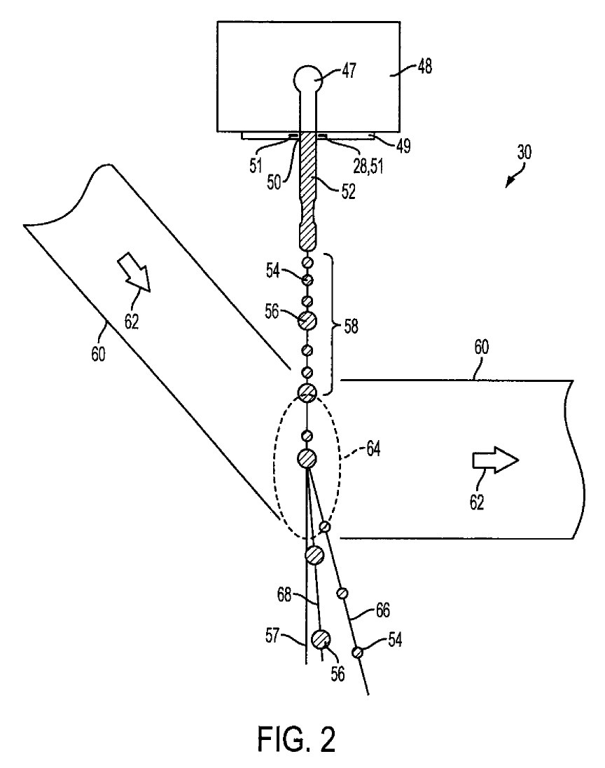

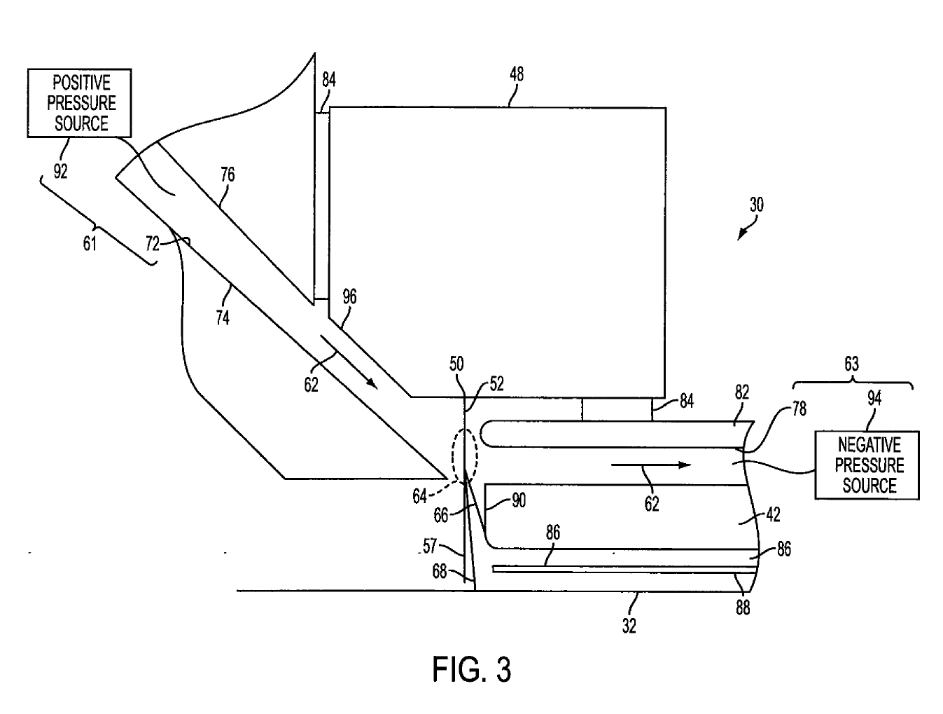

The ink is distributed to printhead 30 through an ink channel 47. The ink preferably flows through slots and/or holes etched through a silicon substrate of printhead 30 to its front surface, where a plurality of nozzles and drop forming mechanisms, for example, heaters, are situated. When printhead 30 is fabricated from silicon, drop forming mechanism control circuits 26 can be integrated with the printhead. Printhead 30 also includes a deflection mechanism (not shown in FIG. 1) which is described in more detail below with reference to FIGS. 2 and 3.

Referring to FIG. 2, a schematic view of continuous liquid printhead 30 is shown. A jetting module 48 of printhead 30 includes an array or a plurality of nozzles 50 formed in a nozzle plate 49. In FIG. 2, nozzle plate 49 is affixed to jetting module 48. However, as shown in FIG. 3, nozzle plate 49 can be integrally formed with jetting module 48.

Liquid, for example, ink, is emitted under pressure through each nozzle 50 of the array to form filaments of liquid 52. In FIG. 2, the array or plurality of nozzles extends into and out of the figure.

Jetting module 48 is operable to form liquid drops having a first size or volume and liquid drops having a second size or volume through each nozzle. To accomplish this, jetting module 48 includes a drop stimulation or drop forming device 28, for example, a heater or a piezoelectric actuator, that, when selectively activated, perturbs each filament of liquid 52, for example, ink, to induce portions of each filament to breakoff from the filament and coalesce to form drops 54, 56.

In FIG. 2, drop forming device 28 is a heater 51 located in a nozzle plate 49 on one or both sides of nozzle 50. This type of drop formation is known and has been described in, for example, U.S. Pat. No. 6,457,807 B1, issued to Hawkins et al., on Oct. 1, 2002; U.S. Pat. No. 6,491,362 B1, issued to Jeanmaire, on Dec. 10, 2002; U.S. Pat. No. 6,505,921 B2, issued to Chwalek et al., on Jan. 14, 2003; U.S. Pat. No. 6,554,410 B2, issued to Jeanmaire et al., on Apr. 29, 2003; U.S. Pat. No. 6,575,566 B1, issued to Jeanmaire et al., on Jun. 10, 2003; U.S. Pat. No. 6,588,888 B2, issued to Jeanmaire et al., on Jul. 8, 2003; U.S. Pat. No. 6,793,328 B2, issued to Jeanmaire, on Sep. 21, 2004; U.S. Pat. No. 6,827,429 B2, issued to Jeanmaire et al., on Dec. 7, 2004; and U.S. Pat. No. 6,851,796 B2, issued to Jeanmaire et al., on Feb. 8, 2005, the disclosures of which are incorporated by reference herein.

Typically, one drop forming device 28 is associated with each nozzle 50 of the nozzle array. However, a drop forming device 28 can be associated with groups of nozzles 50 or all of nozzles 50 of the nozzle array.

When printhead 30 is in operation, drops 54, 56 are typically created in a plurality of sizes or volumes, for example, in the form of large drops 56, a first size or volume, and small drops 54, a second size or volume. The ratio of the mass of the large drops 56 to the mass of the small drops 54 is typically approximately an integer between 2 and 10. A drop stream 58 including drops 54, 56 follows a drop path or trajectory 57.

Printhead 30 also includes a gas flow deflection mechanism 60 that directs a flow of gas 62, for example, air, past a portion of the drop trajectory 57. This portion of the drop trajectory is called the deflection zone 64. As the flow of gas 62 interacts with drops 54, 56 in deflection zone 64 it alters the drop trajectories. As the drop trajectories pass out of the deflection zone 64 they are traveling at an angle, called a deflection angle, relative to the undeflected drop trajectory 57.

Small drops 54 are more affected by the flow of gas than are large drops 56 so that the small drop trajectory 66 diverges from the large drop trajectory 68. That is, the deflection angle for small drops 54 is larger than for large drops 56. The flow of gas 62 provides sufficient drop deflection and therefore sufficient divergence of the small and large drop trajectories so that catcher 42 (shown in FIGS. 1 and 3) can be positioned to intercept one of the small drop trajectory 66 and the large drop trajectory 68 so that drops following the trajectory are collected by catcher 42 while drops following the other trajectory bypass the catcher and impinge a recording medium 32 (shown in FIGS. 1 and 3).

When catcher 42 is positioned to intercept large drop trajectory 68, small drops 54 are deflected sufficiently to avoid contact with catcher 42 and strike the print media. As the small drops are printed, this is called small drop print mode. When catcher 42 is positioned to intercept small drop trajectory 66, large drops 56 are the drops that print. This is referred to as large drop print mode.

Referring to FIG. 3, jetting module 48 includes an array or a plurality of nozzles 50. Liquid, for example, ink, supplied through channel 47, is emitted under pressure through each nozzle 50 of the array to form filaments of liquid 52. In FIG. 3, the array or plurality of nozzles 50 extends into and out of the figure.

Drop stimulation or drop forming device 28 (shown in FIGS. 1 and 2) associated with jetting module 48 is selectively actuated to perturb the filament of liquid 52 to induce portions of the filament to break off from the filament to form drops. In this way, drops are selectively created in the form of large drops and small drops that travel toward a recording medium 32.

Positive pressure gas flow structure 61 of gas flow deflection mechanism 60 is located on a first side of drop trajectory 57. Positive pressure gas flow structure 61 includes first gas flow duct 72 that includes a lower wall 74 and an upper wall 76. Gas flow duct 72 directs gas flow 62 supplied from a positive pressure source 92 at downward angle θ of approximately a 45° relative to liquid filament 52 toward drop deflection zone 64 (also shown in FIG. 2). An optional seal(s) 84 provides an air seal between jetting module 48 and upper wall 76 of gas flow duct 72.

Upper wall 76 of gas flow duct 72 does not need to extend to drop deflection zone 64 (as shown in FIG. 2). In FIG. 3, upper wall 76 ends at a wall 96 of jetting module 48. Wall 96 of jetting module 48 serves as a portion of upper wall 76 ending at drop deflection zone 64.

Negative pressure gas flow structure 63 of gas flow deflection mechanism 60 is located on a second side of drop trajectory 57. Negative pressure gas flow structure includes a second gas flow duct 78 located between catcher 42 and an upper wall 82 that exhausts gas flow from deflection zone 64. Second duct 78 is connected to a negative pressure source 94 that is used to help remove gas flowing through second duct 78. An optional seal(s) 84 provides an air seal between jetting module 48 and upper wall 82.

As shown in FIG. 3, gas flow deflection mechanism 60 includes positive pressure source 92 and negative pressure source 94. However, depending on the specific application contemplated, gas flow deflection mechanism 60 can include only one of positive pressure source 92 and negative pressure source 94.

Gas supplied by first gas flow duct 72 is directed into the drop deflection zone 64, where it causes large drops 56 to follow large drop trajectory 68 and small drops 54 to follow small drop trajectory 66. As shown in FIG. 3, small drop trajectory 66 is intercepted by a front face 90 of catcher 42. Small drops 54 contact face 90 and flow down face 90 and into a liquid return duct 86 located or formed between catcher 42 and a plate 88. Collected liquid is either recycled and returned to ink reservoir 40 (shown in FIG. 1) for reuse or discarded. Large drops 56 bypass catcher 42 and travel on to recording medium 32. Alternatively, catcher 42 can be positioned to intercept large drop trajectory 68. Large drops 56 contact catcher 42 and flow into a liquid return duct located or formed in catcher 42. Collected liquid is either recycled for reuse or discarded.

As shown in FIG. 3, catcher 42 is a type of catcher commonly referred to as a “Coanda” catcher. However, the “knife edge” catcher shown in FIG. 1 and the “Coanda” catcher shown in FIG. 3 are interchangeable and work equally well. Alternatively, catcher 42 can be of any suitable design including, but not limited to, a porous face catcher, a delimited edge catcher, or combinations of any of those described above.

Some or all of printing system components or devices described above communicate with each other. Communication includes transferring or transmitting (sending and/or receiving) information or data in a secure manner without encrypting the information itself. When appropriate, the transferred information or data is used or stored by at least one of the printing system devices.

The information or data that is transmitted and stored can be of various types. For example, the information can be data used by the printing system controller to optimize settings of various control parameters for one or more printheads to ensure print quality and printhead reliability. The information can include printhead operating history information such as ink types and/or other fluid types that have been used in a printhead. Additionally, the information can include business or billing related information such as printhead usage (printhead hours), billing method, speed limitations of the printhead, and/or other sensitive or proprietary information.

The stored information is used for various purposes. For example, the stored history information can be used by the host to block transfer of a fluid to a particular printhead in situations in which it may not be appropriate to mix that fluid with a fluid already present in the printhead. An example of this use of the information includes preventing the transfer of a cyan ink to a printhead being operated with magenta ink.

When the information is based at least in part on customer use data and/or used to bill or change a user of the printing system, it is preferable that this type of information be secure so that the information cannot be modified or copied from one printing system component, for example, from one printhead to another printhead. It is also preferable that the information not be destroyed, erased, forged (spoofed), or emulated. However, except in situations where the information itself is confidential or proprietary, there is typically no reason to keep the information itself from being decipherable by users of the printing system.

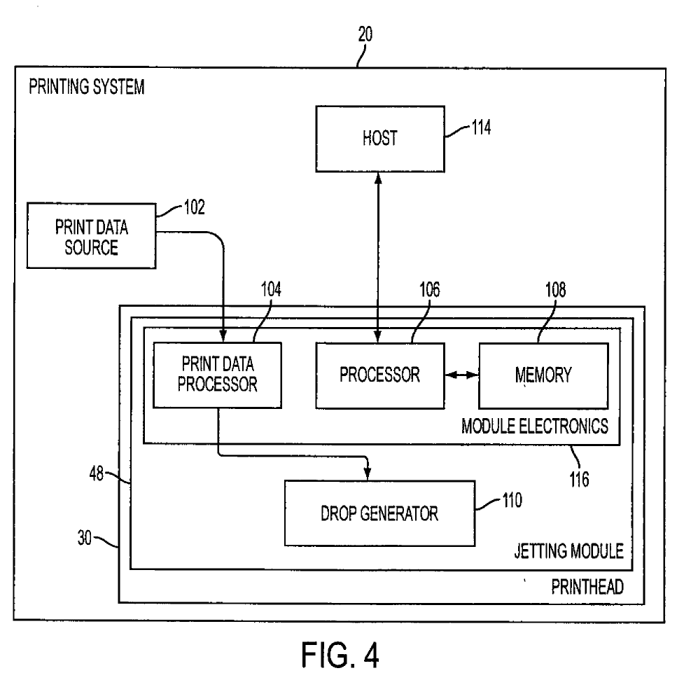

Referring to FIG. 4, a schematic block diagram showing the relationship between jetting module 48 and a host of inkjet printing system 20 is shown. Inkjet printing system 20 includes a field replaceable unit, typically, either printhead 30 or jetting module 48. When printhead 30 is a printhead in a continuous printing system, printhead 30 includes a deflection system and a jetting module. When printhead 30 is a printhead in a drop on demand printing system, printhead 30 is the jetting module. Field replaceable jetting module 48 includes a drop forming mechanism(s), commonly referred to as a drop generator 110, and module electronics 116. Additionally, printing system 20 includes a host system 114, to which the jetting module 48 or printhead 30 connects to, and a print data source 102. The jetting module 48 or printhead 30 includes printhead memory 108 that can contain information or data. Sometimes this data is needed by the host 114 to optimize jetting module 48 or printhead 30 operation. Sometimes the data is related to the operating history of the jetting module or printhead. In some instances, the at least some of the data contained in printhead memory 108 is originally supplied by the host 114.

Communication between the printhead memory 108 and the host 114 passes through the printhead microprocessor 106. The printhead memory 108, the printhead microprocessor 106, and a print data processor 104 form what is commonly referred to as module electronics 116 of the jetting module 48 or printhead 30. A print data source 102, for example, a scanner or computer, provides digital data, for example, raster image data, outline image data in the form of a page description language, or digital image data to the print data processor 104. Print data processor 104 converts the image data into a data form that can be sent to the drop generator 110 of jetting module 48 or printhead 30. To help ensure the integrity of the data stored in the printhead memory 108, host 114 and module electronics 116 should be physically secure and tamper-resistant to reduce the likelihood of these devices being altered, copied, or destroyed.

As described below, the host 114 is a fluid system. However, it should be understood that the host can be included in any printing system component. For example, the host 114 can be a fluid system, another printhead, a user interface, a jetting module, a printer controller, or another inkjet system component. When host 114 is a fluid system, the fluid system CPU typically communicates with the printhead microprocessor 106.

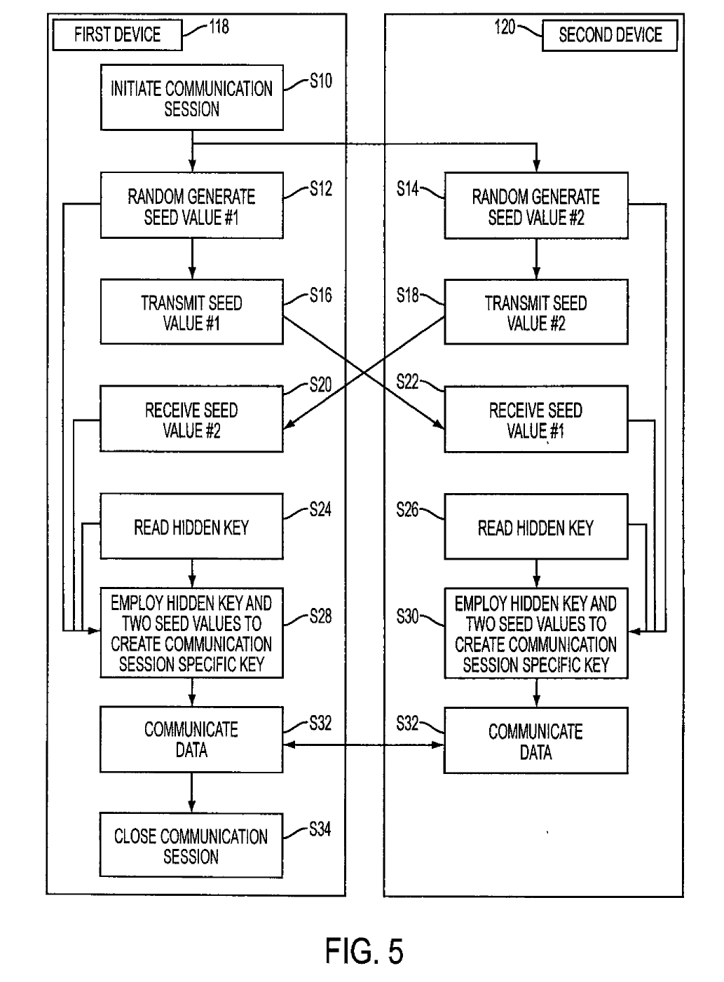

Referring to FIG. 5, when a first device 118, for example, the fluid system CPU, wishes to transfer information or data to a second device 120, for example, the jetting module, the first device initiates a communication session S10 with the second device. During this communication session, a communication session specific encryption key is generated. The communication session specific encryption key is used along with an encryption algorithm to encrypt the messages sent during the communication session. Each communication session employs a different communication session specific encryption key, making the system more secure when compared to systems employing the same encryption key for all messages sent over the lifetime of the system.

After the communication session has been initiated, both the first device 118 and the second device 120 independently generate a random seed value S12, S14. The first device 118 transmits seed value 1 to the second device S16 while the second device 120 transmits seed value 2 to the first device S18. The seed values are received by the appropriate devices S20, S22. Each device reads a stored hidden key S24, S26 that is common to the first device 118 and the second device 120 but not transmitted, therefore remaining independently known only to the first device 118 and the second device 120. Each device now has the seed value it created, the seed value created by the other device, and the stored hidden key.

The seed value provided by first device 118, the seed value provided by the second device 120, and the hidden key known to both the first device 118 and second device 120 are collectively employed to form a communication session specific key S28, S30. For example, in one example embodiment of the invention, the seed value provided by the second device 120 (for example, a jetting module) and the seed value provided by the first device 118 (for example, a fluid system) are combined to form a communication session specific number, which is then put through an encryption algorithm using the hidden key as the encryption key. The resultant number is the communication session specific key. Because both devices use the same hidden key and the same encryption algorithm, the communication session specific key created by first device 118 is identical to the communication session specific key created by second device 120.

While any encryption algorithm known in the art can be used, typically, the particular encryption algorithm employed depends on the security level desired for the specific application being contemplated. Examples of encryption algorithm include TDES (or 3DES), AES, Lucifer, Madryga, REDOC, RC2, IDEA, MMB, GOST, CAST, as well as other conventional block ciphers. In a preferred example embodiment, the encryption algorithm is TDES. First and second devices 118, 120 then communicate or transfer the information or data S32.

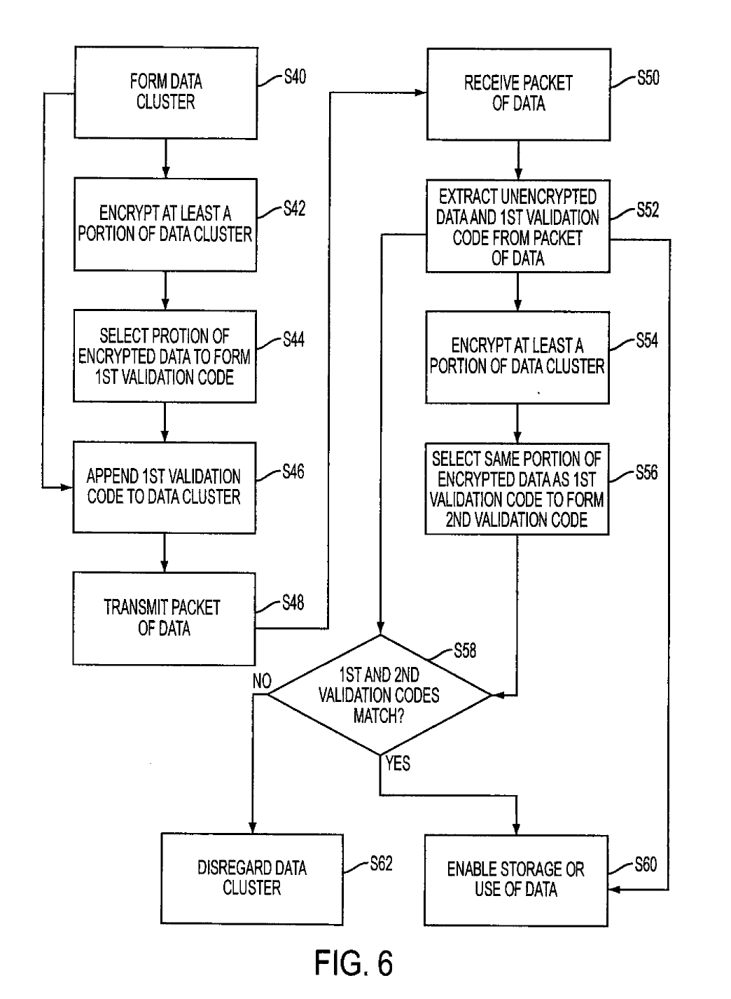

Referring to FIG. 6, the information transferring process S32 is shown. As the communication between devices is bidirectional, the terms “sender” and “receiver” are used herein, and include, for example, a fluid system, a printhead, a user interface, and/or other inkjet system components.

The data to be transmitted from the first device 118 (for example, the fluid system) to the second device 120 (for example, the printhead), or vice-versa, is identified S40. At least a portion of the data cluster to be transmitted is encrypted using the communication session specific encryption key previously created S42. The encryption algorithm used can be the same as the algorithm used to create the communication session specific key or it can be a different algorithm. The portion of the data cluster to be encrypted depends on the specific application contemplated and can be, for example, the entire data cluster that is to be transmitted or a subset of the entire data cluster.

At least a portion of the encrypted data cluster is then selected to form a validation code S44. Again, the portion of encrypted data selected to form the validation code depends on the specific application contemplated and the system specifics, including how many bytes are available as a validation code, the amount of total encrypted data, and the amount of unencrypted data to be transmitted. For example, if only a small portion of unencrypted data is encrypted, the validation code can be all of the encrypted data. However, when a larger portion of the data is encrypted, the validation code can be only a few bytes of the encrypted data. These bytes can come from the beginning, middle, end, or from multiple locations of the encrypted data string. This validation code is appended to the unencrypted data cluster previously identified S46 to create a packet of data that is transmitted by the sender to the receiver S48. It is preferred that the validation code be at least two bytes or 16 bits long to reduce the risk that one could correctly guess the validation code on any given transfer of a data cluster.

The integrity of the data validation method depends on the secrecy of the hidden key. The process of forming a validation key from only a portion of the encrypted data rather than the entire encrypted data actually makes it harder to discover the value of the hidden key. Similarly, encrypting only a portion of the data cluster rather than encrypting the entire data cluster also makes it harder to discover the value of the hidden key. In both of cases, the process or algorithm used to define the data portion should be kept confidential.

The packet of data is received by the receiver S50. The receiver then extracts, or separates, the received data packet into the original unencrypted data cluster and the validation code S52. The receiver encrypts at least a portion of the extracted unencrypted data using the communication session specific encryption key previously created S54 and selects at least a portion of the encrypted data cluster to form a second validation code S56. The validation code calculated by the receiver is compared to the validation code extracted from the data received from the sender S58. When there is a match between the two validation codes, the receiver uses the unencrypted data S60. For example, the information can be written to the printhead memory or displayed on a user interface.

However, when there is not a match of the validation codes, the information is disregarded S62. In some cases, such as in the described embodiment where the first device 118 (sender) is a fluid system and the second device 120 (receiver) is a jetting module, disregarding the information takes the form of refusing to write the data to the printhead memory. However, when there is no match of the validation codes during several successive tries, communication can be permanently shut down to the jetting module. In such cases, the customer is typically required to contact the manufacturer to correct the problem and replace the jetting module. When the first device 118 (sender) is, for example, the jetting module and the second device (receiver) is, for example, the fluid system, disregarding the information can take the form of inhibiting operation of the system.

In the description above, it was discussed relative to steps S42 and S44 that at least a portion of the data cluster is encrypted and that at least a portion of the encrypted data is selected to form a validation code. The portion of unencrypted data that is encrypted in step S54 and the portion of encrypted data selected to form the second validation code in step S56 should correspond to the portion of the unencrypted data encrypted in step S42 and the portion of encrypted data selected to form the first validation code in step S44. In other words, if all of the data is encrypted in step S42, all of the data should be encrypted in step S54, and if, by way of example, the first four bytes of the encrypted data are selected as the first validation code in step S44, the first four bytes of encrypted data should be selected as the second validation code in step S56. To ensure that matching portions are selected by the sender and the receiver, the portions to be selected are usually fixed and do not vary from one communication session to another. Alternatively, when a communications session is initiated in S10, some information can be communicated between the first device 118 and the second device 120 to declare what portions of the unencrypted data are to be selected for encryption and which portions of the encrypted data are selected to form the validation codes.

Referring back to FIG. 5, when the transfer of information is complete, the communication session is closed S34. As such, each time the devices wish to communicate with one another, a new communication session is initiated, and a new encryption key is used.

The invention has been described in detail with particular reference to certain preferred embodiments thereof, but it will be understood that variations and modifications can be effected within the scope of the invention.

### PARTS LIST

20 continuous printer system
22 image source
24 image processing unit
26 mechanism control circuits
28 device
30 printhead
32 recording medium
34 recording medium transport system
36 recording medium transport control system
38 micro-controller
40 reservoir
42 catcher
44 recycling unit
46 pressure regulator
47 channel
48 jetting module
49 nozzle plate
50 plurality of nozzles
51 heater
52 liquid
54 drops
56 drops
57 trajectory
58 drop stream
60 gas flow deflection mechanism
61 positive pressure gas flow structure
62 gas flow
63 negative pressure gas flow structure
64 deflection zone
66 small drop trajectory
68 large drop trajectory
72 first gas flow duct
74 lower wall
76 upper wall
78 second gas flow duct
82 upper wall
86 liquid return duct
88 plate
90 front face
92 positive pressure source
94 negative pressure source
96 wall
102 print data source
104 print data processor
106 printhead microprocessor
108 printhead memory
110 drop generator
114 host system
116 module electronics
118 first device
120 second device

1. A method of communicating between a first device and a second device comprising:
providing unencrypted data to be transmitted in the first device;
encrypting at least a portion of the unencrypted data to be transmitted to form encrypted data;
using at least a portion of the encrypted data to form a first validation code;
appending the first validation code to the unencrypted data to form a packet of data to be transmitted; and
transmitting the packet of data from the first device to the second device.

2. The method of claim 1, wherein after the second device receives the transmitted packet of data from the first device, the method further comprises:
extracting the unencrypted data from the received packet of data;
extracting the first validation code from the received packet of data;
encrypting at least a portion of the extracted unencrypted data, the portion of extracted unencrypted data encrypted by the second device corresponding to the portion of unencrypted data encrypted by the first device;
using at least a portion of the extracted encrypted data to form a second validation code calculated by the second device, the portion of the extracted encrypted data that forms the second validation code corresponding to the portion of the encrypted data that forms the first validation code; and
comparing the second validation code to the first validation code.

3. The method of claim 2, further comprising:
disregarding the transmitted unencrypted data when there is not a match of the second validation code and the first validation code.

4. The method of claim 3, wherein disregarding the transmitted unencrypted data when there is not a match of the second validation code and the first validation code includes inhibiting operation of the system when the second device is a fluid system.

5. The method of claim 3, wherein disregarding the transmitted unencrypted data when there is not a match of the second validation code and the first validation code includes refusing to write the data to memory when the second device is a printhead.

6. The method of claim 3, wherein disregarding the transmitted unencrypted data when there is not a match of the second validation code and the first validation code includes permanently shutting down communication to the second device when the second device is a jetting module.

7. The method of claim 2, further comprising:
using the transmitted unencrypted data when there is a match of the second validation code and the first validation code.

8. The method of claim 1, wherein encrypting at least a portion of the unencrypted data includes using an encryption algorithm selected from the group including TDES, AES, Lucifer, Madryga, REDOC, RC2, IDEA, MMB, GOST, and CAST.

9. The method of claim 1, wherein the encryption algorithm employs a communication session specific key.

10. The method of claim 9, wherein the communication session specific key is generated using random numbers provided by the first device and the second device in combination with a hidden key known only to both the first device and the second device.

11. An inkjet printing system comprising:
a first device including unencrypted data to be transmitted, the first device being configured to encrypt at least a portion of the unencrypted data to be transmitted to form encrypted data, to use at least a portion of the encrypted data to form a first validation code, and to append the first validation code to the unencrypted data to form a packet of data to be transmitted;
a second device; and
a communication link that connects the first device and the second device, the communication link being configured to transmit the packet of data from the first device to the second device.

12. The system of claim 11, wherein the second device is configured to extract the unencrypted data from the received packet of data, extract the first validation code from the received packet of data, encrypt at least a portion of the extracted unencrypted data, the portion of extracted unencrypted data encrypted by the second device corresponding to the portion of unencrypted data encrypted by the first device, use at least a portion of the extracted encrypted data to form a second validation code, the portion of the extracted encrypted data that forms the second validation code corresponding to the portion of the encrypted data that forms the first validation code, and compare the second validation code to the first validation code.

13. The system of claim 12, wherein the second device is configured to disregard the transmitted unencrypted data when the second validation code and the first validation code do not match each other.

14. The system of claim 13, the second device being a fluid system, wherein the fluid system is configured inhibit operation of the printing system when the second validation code and the first validation code do not match each other.

15. The system of claim 13, the second device being a printhead, wherein the printhead is configured to refuse to write the data to memory when the second validation code and the first validation code do not match each other.

16. The system of claim 13, the second device being a jetting module, wherein the jetting module is configured to permanently cease communication when the second validation code and the first validation code do not match each other.

17. The system of claim 12, wherein the second device is configured to use the transmitted unencrypted data when the second validation code and the first validation code match each other.

18. The system of claim 11, wherein at least one of the first device and the second device is selected from the group consisting of a printhead, a jetting module, a fluid system, and a user interface.

19. The system of claim 11, wherein the encryption algorithm includes a communication session specific key.

20. The system of claim 19, wherein the communication session specific key is generated using random numbers provided by the first device and the second device in combination with a hidden key known only to both the first device and the second device.
